(19) United States
(12) Patent Application Publication
(10) Pub. No.: US 2011/0304813 A1
(43) Pub. Date: Dec. 15, 2011

(54) Apparatus for of rimless spectacles

(76) Inventor: Tony Xin Xiao, Chino, CA (US)

(21) Appl. No.: 12/661,313

(22) Filed: Mar. 15, 2010

(51) Int. Cl. G02C 1/02

(52) U.S. Cl. 351/110

(57) ABSTRACT

A pair of rimless spectacles comprises a pair of lenses, a pair of temple units and a bridge. Each lens includes at least two open slots that provided at a predetermined location and an open recess is formed on top of each open slot on the rear side of the lens. The open recess has a declined surface declining from the peripheral edge toward to inner portion of the lens. Each temple unit includes at least one fasten apparatus and the bridge has two, when each fasten apparatuses of each temple units and the bridge has been inserted into the open slot and the open recess of each lenses respectively, the lenses can be securely locked up by the fasten apparatus to form a pair of rimless spectacles while the declined surface of the open recess will block and prevent the fasten apparatus moving out from the lens.

### BACKGROUND OF THE PRESENT INVENTION

1. Field of Invention

The present invention relates to a spectacle frame, and more particularly to a pair of rimless spectacles, wherein the open slots with an open recess that provided at predetermined location of the lenses to engage with the fasten apparatuses of the temples and the bridge, so as to securely mount the temples and the bridge onto the lenses to form a pair of rimless spectacles.

2. Description of Related Arts

A conventional rimless frame is one of very common spectacles being used in the market today. Structurally, the rimless spectacles comprise lenses, temples, and a bridge directly connecting two lenses, wherein more than one connection holes are on each lens, such that the temples and the bridge are connected at the connection holes respectively.

There are two basic mounting mechanisms in current market place. One is so called screw-mounted and other is snap-on. The disadvantage for screw-mounted mechanism is that when the wearer wears the glasses in amount of time, the screw nut may easily loose; and for the snap-on mechanism, the problem came from difficulty of installation. Both mechanisms have same major disadvantage which is difficult to make holes precisely on the lens. Since the lens is generally curved, when drilling the holes on the lens, the drilling device has to be perpendicular to the surface to be drilled to achieve the best drilling effect and accuracy. If the requirement of accuracy on the holes were failed, then the final rimless spectacles will be either crooked or the lens may easily break.

Recently another new innovation is come from U.S. Pat. No. 7,658,492 B2. The inventor has disclosed a cam mechanism and a latch for facilitating assemble of rimless spectacles. The mounting process is simple, easy and in tool-less manner. But unfortunately, the design still has several disadvantages and limitations that never being overcome. For example, this design is only good for mounting negative lens, but it is not workable for positive lens and flat lens. On the other hand, the connector member is clipping outside of the lens so that it cosmetically affect appearance of frame for its fashion need.

The present invention introduces a new method to overcome the problems of the disadvantage and the limitation as mentioned above, which will be no doubt, substantially benefit manufacturers as well as wearers.

### SUMMARY OF THE PRESENT INVENTION

The main object of the present invention is to provide a special fasten apparatus for rimless spectacles, which is adapted for mounting a pair of lenses to form a pair of rimless spectacles.

Another object of the present invention is to provide rimless spectacles, wherein each of the lenses thereof has two open slots with an open recess for engaging to the fasten apparatuses from a pair of temples and a bridge to form a pair of rimless spectacles.

Another object of the present invention is to provide rimless spectacles, wherein it is not necessary to drill any hole on the lenses. Therefore, the difficulty in Lab jobs is reduced while the optician installing prescription glasses.

Another object of the present invention is to provide rimless spectacles, wherein the mounting mechanism is entirely concealed inside the lens, so that this innovation does not cosmetically affect appearance of the spectacles, which will benefit manufacturers, frame designers as well as wearers for their fashion need.

In order to accomplish the goal of the present invention, the rimless spectacles comprise:

A pair of lenses, each lens has at least two open slots provided at a predetermined location open from the peripheral edge. Each open slot has an open recess from the rear side of the lens; and

Three mounting mechanisms, which include;

A pair of temple units and a bridge. Each temple unit has at least one fasten apparatus and the bridge has two. Each lenses can be locked up by the fasten apparatus when the open slot has been inserted respectively inside of the fasten apparatus of each temple units and the bridge, so as to form a pair of rimless spectacles.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of rimless spectacles showing basic components of the rimless spectacles according to the preferred embodiments of the present invention.

FIG. 2 is a partial perspective view of the lens showing the open slot and the open recess on the lens.

FIG. 3 is a sectional view of a negative lens showing the open slot and the open recess with the declined surface on the lens.

FIG. 4 is a sectional view of a negative lens showing the open slot and the open recess forming a “T” shape in cross section.

FIG. 5 is a front view of a negative lens showing the open slot and the open recess on the lens.

FIG. 6 is a sectional view of a positive lens showing the open slot and the open recess with the declined surface on the lens.

FIG. 7 is a sectional view of a negative lens showing the open slot, the open recess and the declined surface having a stepped plane on the lens.

FIG. 8 is a sectional view of a flat lens showing the open slot, the open recess and the declined surface having a curved plane on the lens.

FIG. 9 is a sectional view of the structure of the rimless spectacles showing how the fasten apparatus of the bridge and the temple unit mounting the lens in place according to the preferred embodiment of the present invention.

FIG. 10 is a perspective view of the fasten apparatus of the rimless spectacles showing all the components of the fasten apparatus according to the preferred embodiment of the present invention.

FIG. 11 is a sectional view of a mounting structure between the lens and the fasten apparatus showing the fasten components forming a “I” shape in cross section.

FIG. 12 is a sectional view of a mounting structure showing the lens has another open recess which is formed on top of the open slot from the front side of the lens.

FIG. 13 is a sectional view of a mounting structure showing the fasten apparatus is mounted by a locking pin.

### DETAILED DESCRIPTION OF THE PREFERRED EMBODIMENT

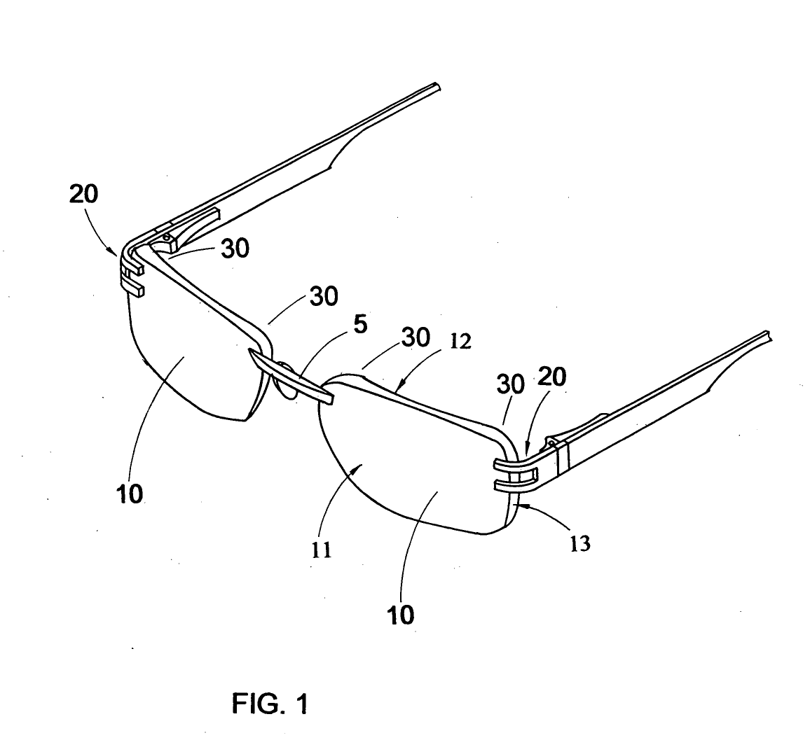

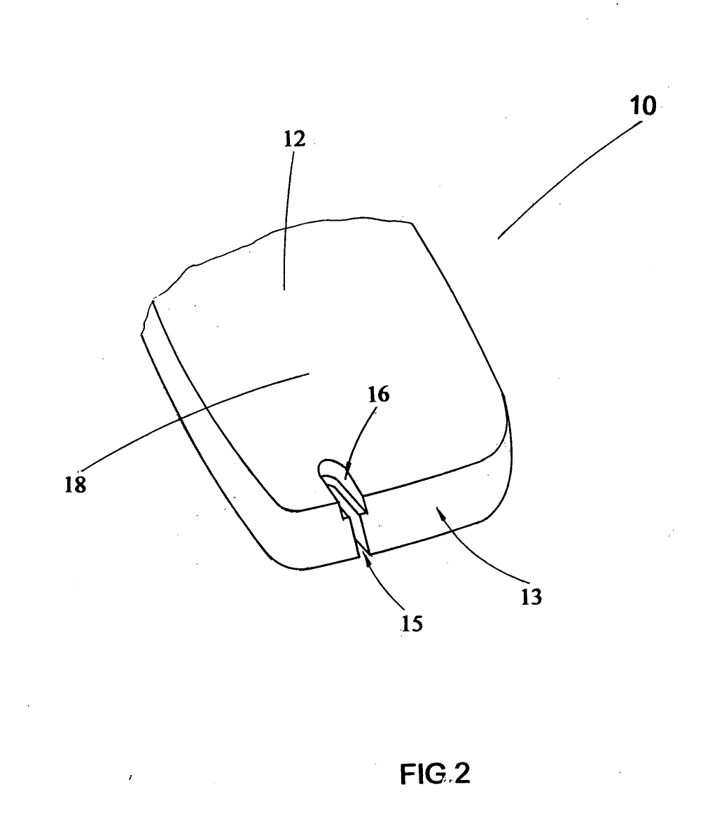

Referring to FIG. 1 and FIG. 2 of the drawings, a pair of rimless spectacles according to the preferred embodiment of the present invention is illustrated, wherein the rimless spectacles comprises two lenses 10, two temple units 20 and a bridge 5. Each of the lenses 10 has a front side 11, a rear side 12, and a peripheral edge 13 located between the laterals of front and the rear sides 11, 12. Each of the lenses 10 further has an open slot 15 which provided at a predetermined location open from peripheral edge 13, and an open recess 16 is formed on top of the open slot 15 from rear side of the lens 10. Each of temple units 20 has at least one fasten apparatus 30 and the bridge 5 has two fasten apparatuses 30. The fasten apparatus 30 of the pair of temple units 20 and the bridge 5 are connected to the open slot 15 respectively at the inner and outer sides of each of the lenses 10 to form the rimless spectacles.

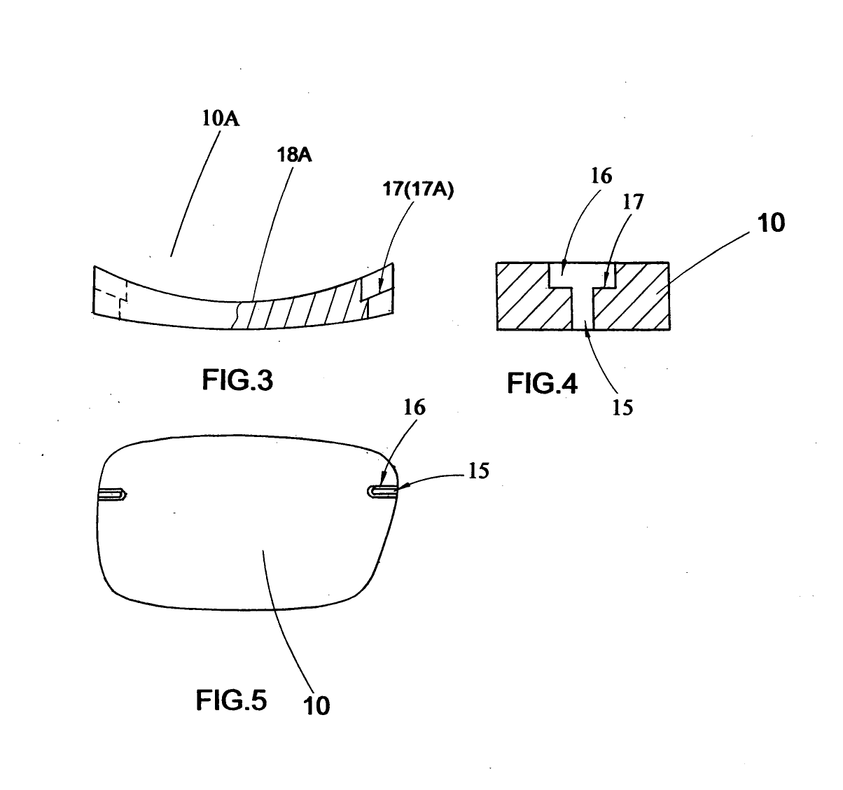

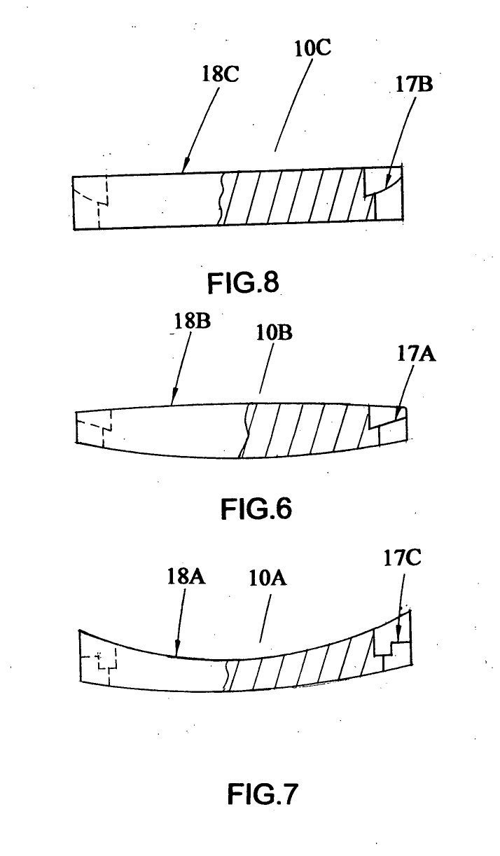

As shown in FIG. 3 to FIG. 8, the open recess 16 has a declined surface 17 declining from the peripheral edge 13 toward to the inner portion 18 of the lens 10, so that the thickness of the lens 10 at the open edge is larger than which at the inner portion of the lens 10. The reason for having the declined surface 17 is because we want the fasten apparatus 30 to be fitted for universal lenses. As we know, there are three kinds of lenses: A negative lens 10A, a positive lens 10B and a flat lens 10C. The negative lens 10A has a concave surface 18A on the rear side of the lens; the positive lens 10B has a convex surface 18B on the rear side of the lens; and the flat lens 10C has a flat surface 18C on the rear side of the lens. In order to lock up the clipping member 32, the declined surface 17 is needed because when the fasten apparatus 30 has been installed into the lens 10, the declined surface 17 will block and prevent the fasten apparatus 30 sliding off from the open edge of the lens 10. In addition, the declined surface 17 can be an inclined plane 17A, a curved plane 17B or a stepped plane 17C as shown in FIG. 6 to FIG. 8. All these planes will function the same for blocking and preventing the fasten apparatus moving out from the lens.

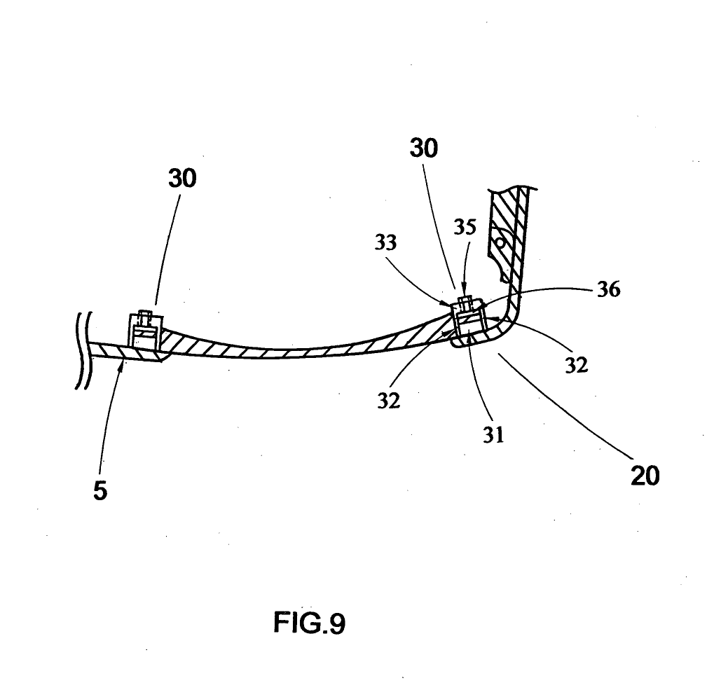

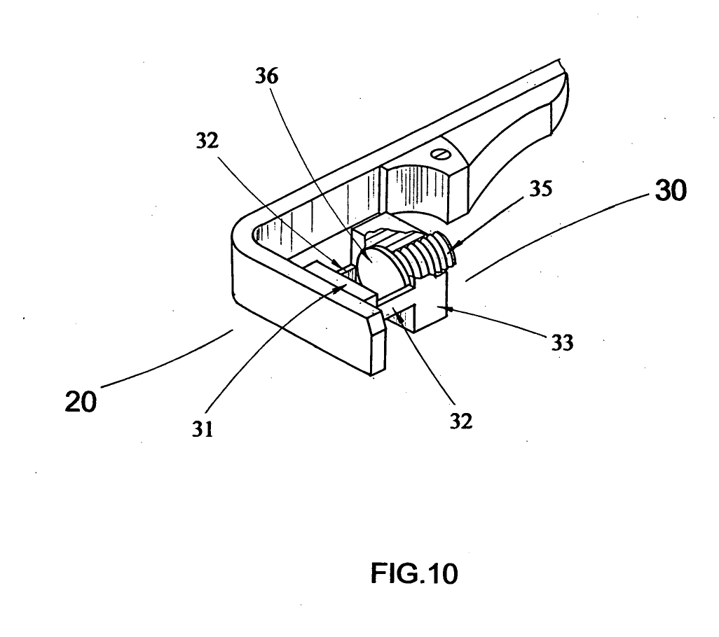

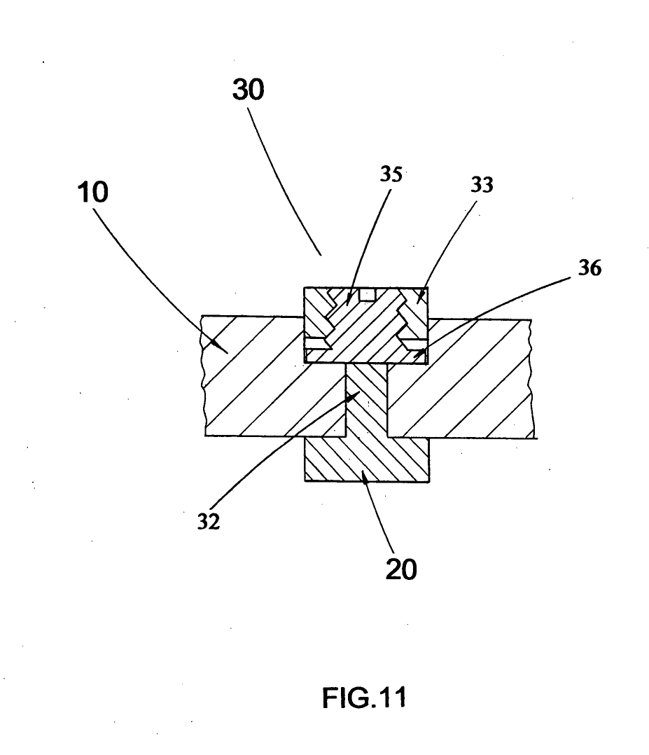

Referring to FIG. 9 to FIG. 11 of the drawings, each of the fasten apparatuses 30 comprises an inserter 31, two extension arms 32 and a clipping member 33. The inserter 31 is extended from the temple units 20 or the bridge 5. Two extension arms 32 being connected from two side of the inserter 31 are integrally extended outward coupling with the clipping member 33. Obviously, the inserter 31, two extension arms 32 and the clipping member 33 as mentioned above have built a frame structure for holding the lens 10 in position through the open slot 15 and the open recess 16 of the lens 10. In addition, the clipping member 33 further has a screw 35 and a screw head 36. When the open slot 15 of the lens 10 has been inserted into the fasten apparatus 30, the screw 35 can be turned in and the screw head 36 will press the declined surface 17 to securely lock up the lens 10 in place. It is worth to mention that the open slot 15 and the open recess 16 is like a “T” shape showing in the cross section of FIG. 4, and the fasten apparatus 30 is like a “I” shape showing in the cross section of FIG. 10. More specifically, the sizes of the inserter 31 and the clipping member 33 are slightly smaller than the sizes of the open slot 15 and the open recess 16. At the same time, the shapes of the inserter 31 and the clipping member 33 are corresponded to the shapes of the open slot 15 and the open recess 16. Therefore, when a rimless spectacles is being assembled, the fasten apparatus 30 can be perfectly inserted into the open slot 15 and the open recess 16 of the lens 10, and securely locked up by the screw 35 while the declined surface 17 is blocking and preventing the fasten apparatus 30 moving out from the open edge of the lens 10.

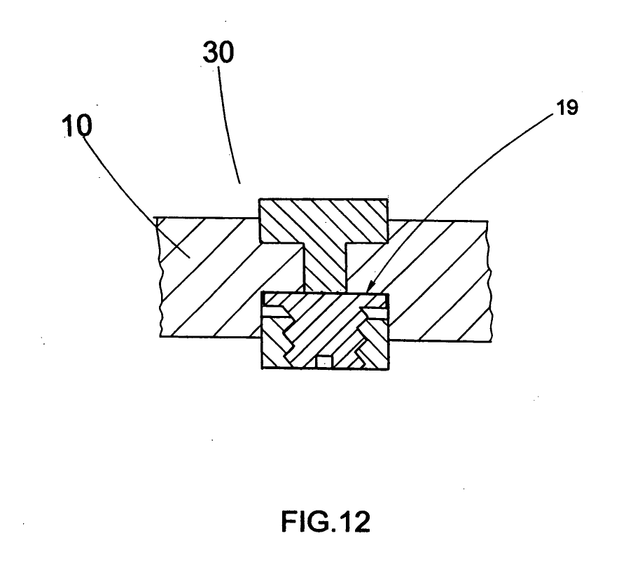

As shown in FIG. 12, the lens has another open recess 19 which is formed on top of the open slot from the front side of the lens, so that the temple units and the bridge can be concealed inside of the front open recess when rimless spectacles is being assembled.

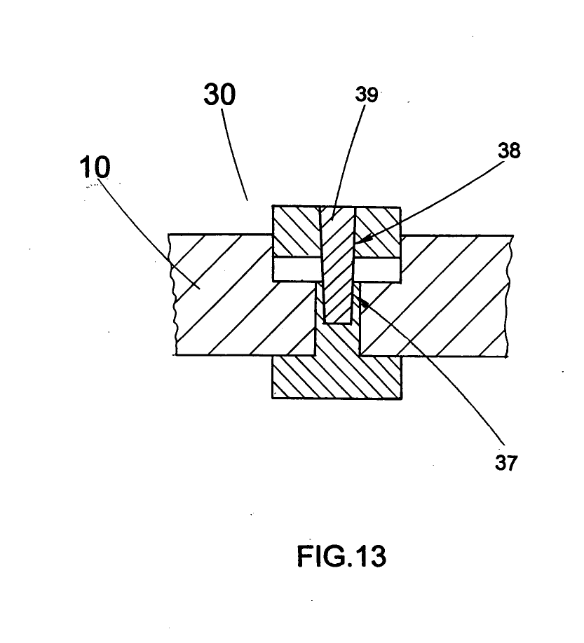

Referring to FIG. 13 of the drawings, instead of using the locking screw, we have a locking pin 39. Further more, the inserter 31 has a locking hole 37 and the clipping member 33 has a through hole 38 so that the lens 10 can be securely lock up by the locking pin 39 when rimless spectacle is being assembled.

It is important to know that the fasten apparatus 30 can be entirely concealed inside the open slot 15 and the open recess 16 of the lens 10, so that this innovation does not cosmetically affect appearance of the spectacles, which will benefit manufacturers the most, frame designers as well as wearers for their fashion need.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pair of rimless spectacles comprises:
A pair of lenses, each of said lenses has a front side, a rear side, and a peripheral edge. Each of said lenses further has at least two open slots that provided at a predetermined location laterally open from said peripheral edge. An open recess is formed on top of each of said open slot from said rear side of said lens. Said open recess further has a declined surface declining from said peripheral edge toward to inner portion of said lens; and
Three mounting mechanisms, which include;
A pair of temple units and a bridge. Each of said temple units has at least one fasten apparatus and said bridge has two fasten apparatuses. Each of said lenses can be locked up when said open slots has been inserted respectively inside of said fasten apparatus of each of said temple units and said bridge while said declined surface of said open recess will block and prevent said fasten apparatus sliding off from said lens.

2. The fasten apparatus of said mounting mechanisms, as recited in claim 1, wherein comprises an inserter, two extension arms and a clipping member. Said inserter is extended from each of said temple units or said bridge. Said two extension arms being connected from said inserter are integrally extended outward coupling with said clipping member. Said clipping member further has a screw, when said fasten apparatus has been inserted into said opening slot and said open recess of said lens, said lens can be securely locked up by said screw.

3. The fasten apparatus of said mounting mechanisms, as recited in claim 2, wherein said inserter and said clipping member have corresponding sizes and shapes to fit into said open slot and said open recess of said lens, so that said fasten apparatus can be concealed inside of said open slot and said open recess of said lens when rimless spectacles has been assembled.

4. The fasten apparatus of said mounting mechanisms, as recited in claim 1, wherein comprises an inserter, two extension arms and a clipping member. Said inserter is extended from each of said temple units or said bridge. Said two extension arms being connected from said inserter are integrally extended outward coupling with said clipping member. Said Clipping member further has a locking pin and a through hole. Said inserter further has a locking hole so that said lens can be securely lock up by the locking pin when rimless spectacle is being assembled

5. A pair of rimless spectacles comprises:
Three mounting mechanisms, which includes a pair of temple units and a bridge. Each of said temple units has at least one fasten apparatus and said bridge has two fasten apparatuses that located at two ends of said bridge respectively; and
A pair of lenses. Each of said lenses has a front side, a rear side, and a peripheral edge. Each of said lenses further has at least two open slots that provided at a predetermined location laterally open from said peripheral edge. An open recess is formed on top of each of said open slot from said rear side of said lens. Said open recess further has a declined surface declining from said peripheral edge toward to inner portion of said lens.
Each of said fasten apparatus comprises an inserter, two extension arms and a clipping member. Said inserter is extended from each of said temple units or said bridge, and said two extension arms being connected from said inserter are integrally extended outward coupling with said clipping member. Said clipping member further has a screw, when said fasten apparatus has been inserted into said opening slot and said open recess of said lens, said lens can be securely locked up by said screw while said declined surface of said open recess will block and prevent said fasten apparatus moving out from said lens.

6. Rimless spectacles as recited in claim 5, wherein each of said lenses further has an open recess which is formed on top of each of said open slots from said front side of said lens, so that each of said temple units and said bridge can be concealed inside of said open slot and said open recess of said lens when rimless spectacles is being assembled.
